(19) United States
(12) Patent Application Publication
(10) Pub. No.: US 2010/0287372 A1
(43) Pub. Date: Nov. 11, 2010

(54) MAIL SERVER AND METHOD FOR SENDING E-MAILS TO THEIR RECIPIENTS

(76) Inventors: Annikki Welin, Solna (SE); Johan Kölhi, Vaxholm (SE); Ulf Olsson, Sollentuna (SE); Tomas Thyni, Jarfalla (SE)

Correspondence Address: ERICSSON INC., 6300 LEGACY DRIVE, M/S EVR 1-C-11, PLANO, TX, 75024, US

(21) Appl. No.: 12/742,305

(22) PCT Filed: Nov. 13, 2007
(86) PCT No.: PCT/SE2007/050843

§ 371 Date: May 11, 2010

(51) Int. Cl. G06F 15/16; H04L 9/32

(52) U.S. Cl. 713/168; 709/203

(57) ABSTRACT

The present invention relates to a mail server for a network. The mail server has a sender part arranged to receive outgoing e-mails from users of the network and to send the received e-mails to their recipients. The sending part is arranged to copy at least some of the contents in the received e-mail to a storage. The sending part provides an amended e-mail based on the received e-mail, said amended e-mail comprising at least one pointer substituting the contents copied to the storage, said pointer pointing at said contents in said storage.

### TECHNICAL FIELD

The present invention relates to e-mail communication. In particular, it concerns a mail server for a private or public network.

It also relates to a network comprising said mail server and a method for sending e-mail in such network.

### BACKGROUND

E-mail communication is today a widely spread communication means. It provides an important tool in the daily work in many businesses. The amount of e-mails that are sent is steadily increasing. However, the increased amounts of e-mails which are handled by company mail servers and by workers within companies cause problems. For example, it has been reported decreasing effectiveness of employees in companies, if the mail server is down. Further, mail boxes of the users have usually a limited size. When the size of the mail box has been exceeded, e-mail traffic can be stopped. This causes heavy inconveniences for the user. This can also be very frustrating. The user has no control over the size of the inbox, as he/she has no control over the amount of e-mails received and the size of the received e-mails.

Further, privacy is weak, since the e-mails are generally not encrypted.

### SUMMARY

One object of the present invention is to solve at least some of the problems mentioned above.

This has been achieved by means of an improved mail server for a network. The mail server has a sender part arranged to receive outgoing e-mails from users of the network and to send the received e-mails to their recipients. The sender part is further arranged to copy at least some of the contents in the e-mail to a storage and to provide an amended e-mail based on the e-mail, said amended e-mail comprising at least one pointer substituting the contents copied to the storage, said pointer pointing at said contents in said storage. Thereafter, the amended e-mail is sent to the recipient.

One advantage of the mail server described above is that the recipients gain better control over the size of their inboxes, as the substantial contents of the received e-mails are still stored at the sender's site. The receiver does not download the contents to his/her own computer until he/she activates the pointer. Further, the business case of sending spam attachments will be reduced since the sender is keeping the contents.

In accordance with one embodiment, the pointer is an address to data managed by a web server, a so called URL. Communication with said address can be encrypted with HTTPS. Thereby the contents stored at the storage server can be transmitted to the recipient over an encrypted tunnel. The term HTTPS indicates a secure HTTP connection.

In accordance with one embodiment, the sender part is arranged to sign, and possibly also encrypt the amended e-mail. The amended e-mail is for example signed with a private key associated to the sender part. The encryption is for example performed using a public key associated to the recipient of the e-mail.

The contents copied to the storage comprises in one example one or a plurality of attachments. Further, the sender part can be arranged to copy the received outgoing e-mail itself with at least some of its contents to the storage. Further, the contents copied to the storage server can be encrypted for example using a key associated to the recipient

The mail server is usually also arranged to receive incoming e-mails. Accordingly, it has a receiver part arranged to receive incoming e-mails and to forward the incoming e-mails to their recipients present in a private or public network served by said mail server.

In one example, the receiver part is arranged to amend the pointer in the received e-mail so as to point at its destination via a proxy server associated with the mail server. If the communication is based on HTTPS, a secure tunnel can thereby be provided between a storage at the sender side and the proxy server. The contents at the tunnel endpoint in the storage can thereby be downloaded to the proxy server through the secure connection. If the contents are an e-mail, the proxy server can then forward the e-mail to the mail server for further transmittal to the recipient.

The receiving part can be arranged to verify the mail server from which an incoming e-mail originates and to, if the originating server is verified, amend the pointer in the received e-mail so as to point at its destination via the proxy server associated with the mail server.

The present invention also relates to a network comprising a mail server and a plurality of clients served by said mail server, wherein the mail server has a sender part in accordance with the above and storage in accordance with the above.

The present invention further relates to a network comprising a mail server, a plurality of clients served by said mail server, and a proxy server. The mail server has a receiving part arranged to receive incoming e-mails and to send the received e-mails to their recipients within the network. The proxy server is arranged to amend a pointer in the received e-mail so that the pointer points at its destination via the proxy server. Communication is for example encrypted with HTTPS, in which case the amended pointer defines the proxy server as one of the channel endpoints for HTTPS.

The invention further relates to a method for sending e-mails from users in a network and a method for receiving e-mails. Said methods have features corresponding to those described above.

### BRIEF DESCRIPTION OF THE DRAWINGS

FIG. 1 is a block scheme over a first private or public network and a second private network in communication over the Internet.

FIG. 2 is a block scheme over a personal computer in one of the private or public networks in FIG. 1.

FIG. 3 is a flow chart illustrating the operation of a mail server in the first (sending) private or public network in FIG. 1.

FIG. 4 is a flow chart illustrating an example of the operation in the second (receiving) private or public network when e-mails are stored on the storage server of FIG. 1.

FIG. 5 is a flow chart illustrating an example of the operation in the second (receiving) private or public network when attachments are stored on the storage server of FIG. 1.

FIG. 6 is a bock scheme showing an example of a sending part in at least one of the mail servers in FIG. 1.

FIG. 7 is a block scheme showing an example of the storage server in FIG. 1.

FIG. 8 is a bock scheme showing an example of a receiving part in at least one of the mail servers in FIG. 1.

### DETAILED DESCRIPTION

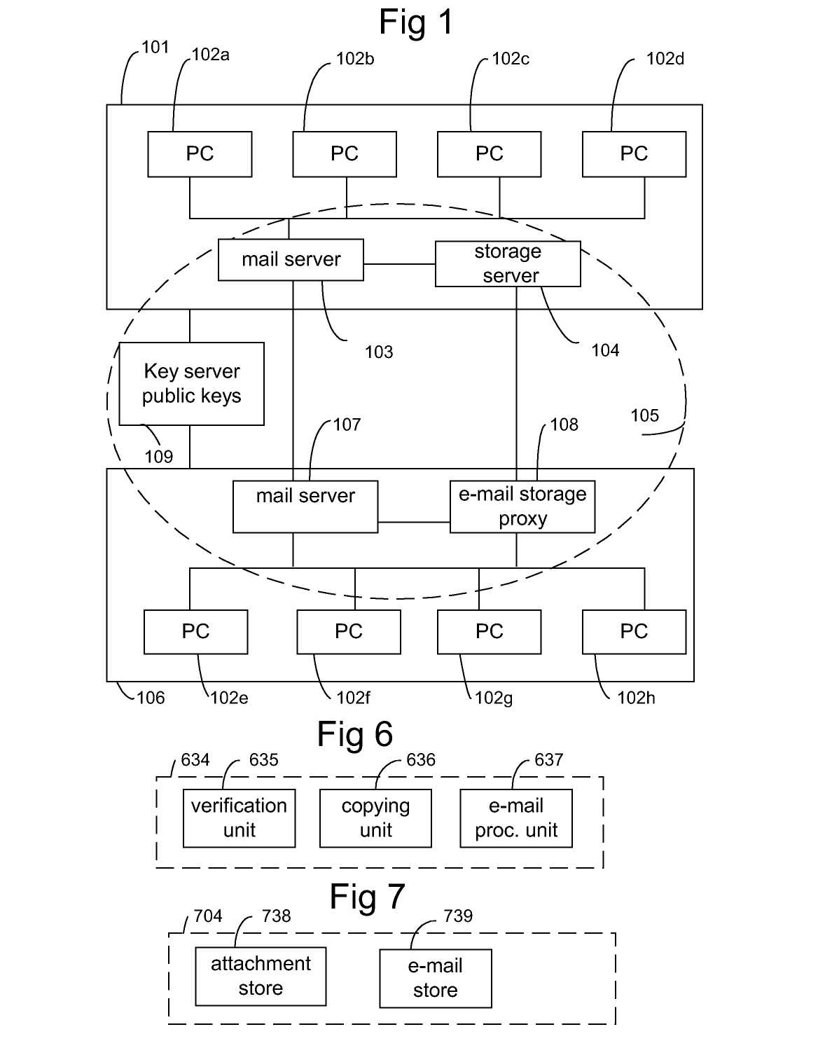

In FIG. 1, a number of personal computers 102a, 102b, 102c, 102d in a first private network 101, for example a company or Internet Service Provider network, are connected to a first mail server 103. The communication between the personal computers 102a, 102b, 102c, 102d and the first mail server 103 takes place for example using SMTP (Simple Mail Transfer Protocol). The first mail server 103 is associated with a storage sever 104 of the first private network 101. Both the first mail server 103 and the storage server 104 of the first private network 101 are available to the Internet 105.

A number of personal computers 102e, 102f, 102g, 102h in a second private network 106, for example a company network, are associated with a second mail server 107. The communication between the personal computers 102e, 102f, 102g, 102h of the second private network 106 and the second mail server 107 takes place for example using POP3 (Post Office Protocol version 3). The second mail server 107 is associated with an e-mail storage proxy server 108 of the second private network 106. Both the second mail server 107 and the e-mail storage proxy server 108 are available to the Internet 105. Thus, data can be communicated between the first mail server 103 and storage server 104 of the first network 101 and the second mail server 107 and e-mail storage proxy server 108 of the second network 106 over the Internet 105.

In the herein described example based on use of a public and private key (PKI), both the first and second networks 101, 106 are in communication with one or a plurality of key servers 109. The key servers 109 are arranged to store the public keys of the users in the networks 101, 106. In one example, the first and second mail servers 103, 107 of the first and second networks 101, 106 are arranged to provide the user's public keys to the key server 109. In another example, the users themselves provide their public keys to the key server 109.

In this description, operations and means for sending e-mails are described in relation to the first network 101 and operations and means for receiving e-mails are described in relation to the second network 106. In practice, both networks have usually means for both sending and receiving e-mails in the herein described manner.

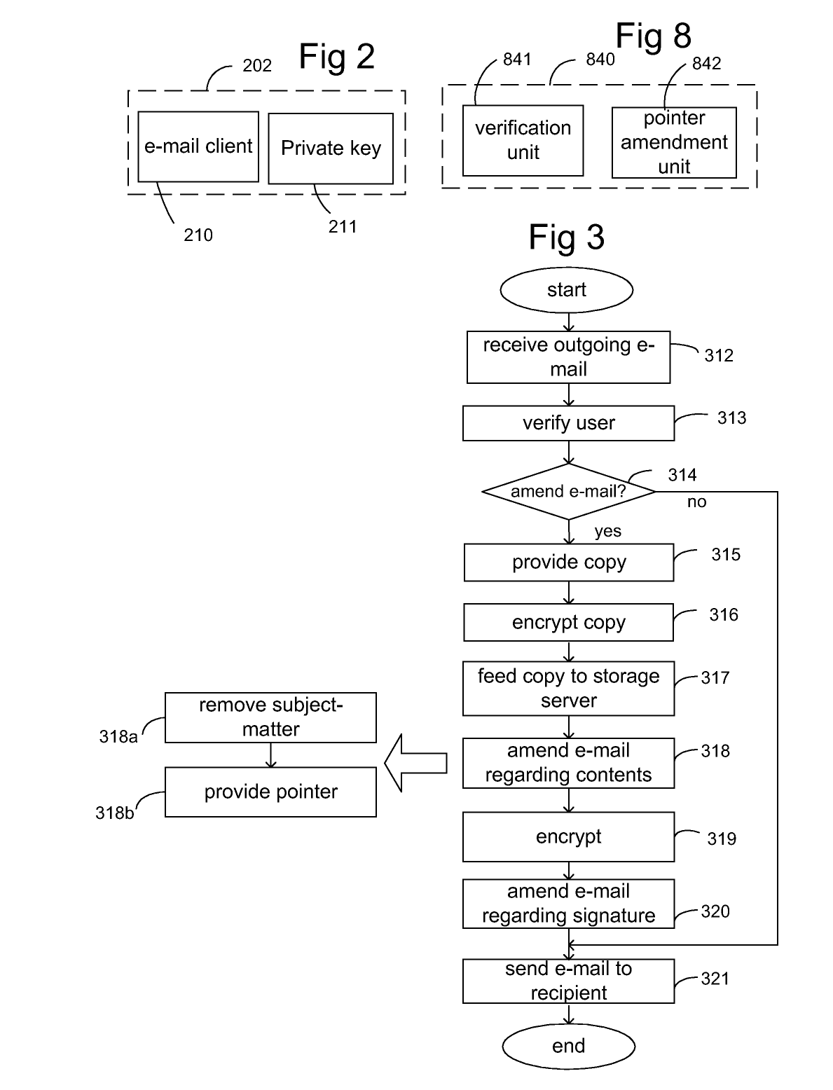

In FIG. 2, the personal computers 202 of the first and second networks 101, 106 are provided with means 210 for e-mail correspondence. The means for e-mail correspondence comprises in one example software arranged to support inclusion of attachment files in the e-mails. In one example, Microsoft Outlook or other commercially available software for e-mailing is installed on, or accessible by, the personal computers 202. The personal computers 202 are associated to one or a plurality of users. In one example, each user has a private key 211 on his/her personal computer. Accordingly, e-mails produced by the user on his/her computer can be digitally signed with the private key of that user. The signing is performed when the e-mail is sent. The public keys are stored in the key server 109, as described above in relation to FIG. 1.

In FIG. 3, the first mail server 103, acting as sender of e-mails in the herein described example, is arranged to receive e-mails in a step 312 from the personal computers 102a, 102b, 102c, 102d of the first private network 101. In the shown example, the first mail server 103 is arranged to verify the identity of the user in a step 313 before processing the incoming mail further. In one example, wherein the received e-mail is signed with the private key of the user who sent the e-mail, the verification is accomplished using the user's public key for authentication of the user in known manner. In this example, the first mail server 103 has stored thereon or access to public keys of the users of the first network. The first mail server 103 is then arranged to process the received e-mails before transmittal to the recipient.

Accordingly, the first mail server 103 is arranged to determine whether the received e-mail is to be directly sent to the recipient or modified before transmittal in a step 314. In one example, the determination is based on the size of the received e-mail. Accordingly, if the e-mail exceeds a predetermined size, then the e-mail is modified in the manner described below before transmittal. If on the other hand, the mail size is smaller than the predetermined size, the e-mail is possibly encrypted in a step 319 and thereafter sent directly to the recipient in a step 321. In another example, the determination is based on the presence of attachments in the mail. Accordingly, if the e-mail comprises one or more attachments, then the e-mail is modified in the manner described below before transmittal. If on the other hand, the e-mail does not comprise any attachments, the e-mail is possible encrypted in the step 319 and thereafter sent to the recipient in the step 321. The determination can be based on a number of other parameters such as the identity of the sender and/or receiver of the e-mail. The encryption step 319 of the e-mail is in one example performed using a public key of the final recipient of the e-mail (the recipient user). The public key of the recipient user is available by means of the key server 109.

If it is determined in the step 314 that the e-mail is to be sent directly to the recipient in the step 321, possibly encrypted in the step 319, the mail server is arranged to send the email further to the recipient without any modifications. The e-mail is in one example sent by SMTP e-mail transport over the Internet.

If it is determined that the e-mail is to be modified, the first mail server 103 is arranged to perform at least some of the steps described in the following with reference to FIG. 3.

In the herein described example, the first mail server 103 is arranged to provide a copy of the received and verified e-mail in a step 315. The received and verified e-mail comprises in one example no attachments. In another example, it comprises one or a plurality of attachments. Irrespective of which, the mail server is in one example arranged to encrypt the copy of the e-mail in a step 316. The copy of the e-mail is for example encrypted in the encryption step 316 with the public key of the recipient user. The public key can be provided from the key server described above. The first mail server 103 is arranged to feed the encrypted e-mail copy to the storage server 104 in a step 317. In an alternative example, the first mail server 103 is not arranged to perform the encryption step 316 so as to encrypt the copy before feeding it to the storage server 104. The storage server 104 can then be arranged to encrypt the copy for example using the public key of the recipient user.

Thus, the copy of the e-mail is stored on the storage server 104 substantially in its original format encrypted with the public key of the recipient user. If the e-mail has been signed by the sending user using a certificate-based method, the signature is in one example not removed from the copy of the e-mail, stored at the storage server. Then, the sender and contents of the e-mail copy can be verified by the recipient user. The storage server 104 is in one example arranged to remove e-mails stored thereon based on preset criteria. In one example, the storage server is arranged to remove e-mails which have been stored thereon for a predetermined time period.

The first mail server 103 is further arranged to provide an amended version of the received e-mail for transmittal to the recipient. In the shown example, the mail server is arranged to perform amendments in a first amendment step 318 of the incoming e-mail related to the contents of the e-mail. In one example, the amendment involves a step 318a of removing all contents from the e-mail (attachments and text written by the sender). In another example the amendment involves a step 318a of removing some of the contents from the e-mail, e.g. all attachments or all attachments of a predetermined format (such as pdf). The first mail server 103 is further arranged to create a pointer to the copy of the original mail stored on the storage server 104 in a step 318b. The pointer is then included in the amended e-mail. The pointer is for example a web server address, a so called URL. In one example, communication with said web server address he is based on encryption with HTTPS. The amendment comprises in one example further including information related to the removed subject matter in the amended e-mail. For example information related to attachments comprised in the original e-mail can be included. The information includes for example file size, creation date, file name, author etc.

In one example, the first mail server 103 is arranged to perform the amendment step 318 by removal and addition of information in the originally received mail. In an alternative example, the amendment is performed by creating a new e-mail. Relevant parts of the original mail are then copied into the created mail and the new information (as described above) is entered into the e-mail.

In the shown example, the first mail server 103 is arranged to perform amendments of the incoming e-mail so as to be identifiable to the second mail server 107 of the second private network. Accordingly, in one example amendments are performed related to the identity of the sender in a second amendment step 320. This amendment step 320 comprises in one example signing the amended e-mail with a private key associated to the first mail server 103. The associated public key is in one example stored at the key server 109. In another example, the first server 103 has sent the second mail server 107 its public key.

The first mail server 103 is arranged to send the amended email further to the recipient's mail server in the sending step 321. The e-mail is in one example sent by SMTP e-mail transport over the internet. In the example illustrated in FIG. 3, the e-mail is encrypted in the encryption step 319 before the amendments are performed related to the identity of the sender in the step 320. The encryption step 319 for encryption of the e-mail is in one example performed using a public key of the final recipient of the e-mail (the recipient user). The public key of the recipient user is available by means of the key server 109.

The steps discussed above performed by the first mail server 103 are not necessarily performed in the above described order.

In an alternative example, the first mail server 103 is not arranged to store a copy of the received e-mail on the storage server 104. Instead, it is arranged to store attachments comprised in the received e-mail on the storage server. In this case, it is possible for the recipient to verify that the received e-mail was forwarded by the first mail server 103. However, it is not possible for the recipient to verify the original sender of the attachment. The pointer described above, comprised in the modified e-mail, is in this alternative example arranged to point at an attachment in the storage server. Accordingly, if the original e-mail comprises a plurality of attachments, the amended mail comprises one pointer for each attachment. The attachments stored at the storage server is in one example encrypted with the public key of the recipient, as described in relation to the example described above, wherein the entire e-mail is stored on the storage server. In yet an alternative example, both the copy of the received e-mail (with or without included attachments, if any) and the attachments are stored on the storage server 104.

In the shown example in FIG. 7 the storage server 104 is arranged to store both attachment files 738 and e-mails 739. In an alternative example, the storage server 104 is arranged to store either attachment files 738 or e-mails 739.

In FIG. 6, a sending part 634 of the at least the first mail server 103 comprises a verification unit 635 arranged to perform the step 313 of verifying the user as described in relation to FIG. 3. The sending part comprises also a copying unit 636 arranged to perform the steps of providing a copy 315 and feeding 317 the copy to the storage server. The copying unit 636 may also be arranged to perform the step 315 so as to encrypt the copy. The sending part comprises also an e-mail processing unit 637 arranged to process the received e-mail in accordance with at least some of the steps 318-320 in FIG. 3 so as to provide an amended e-mail for transmittal to the recipient. The units of the sending part 634 are to be seen as logical units which are implemented in software and/or hardware.

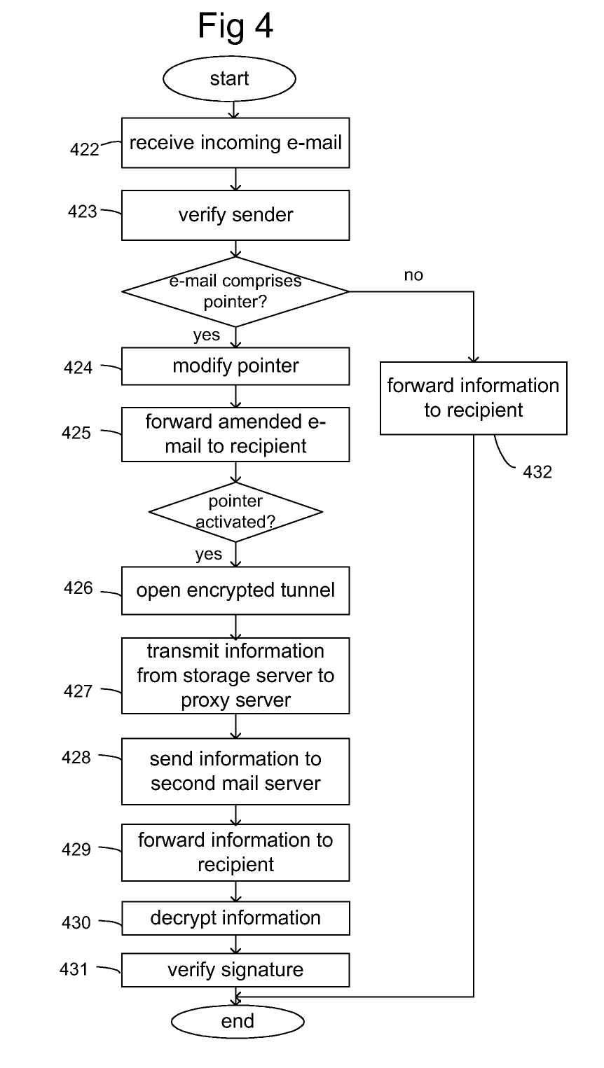

FIG. 4 describes an example, wherein the storage server 104 is arranged to store a copy of the received e-mail (with or without attachments) on the storage server 104. The second mail server 107, serving the recipient, is arranged to receive e-mails for example over SMTP from the Internet in a step 422. If the received e-mail is signed, the second mail server 107 is then arranged to verify the identity of the first mail server 103 from which the received e-mail was sent in a step 423. Accordingly, the digital signature of the first mail server 103 is verified. In an example, wherein the received e-mail is signed based on a public and private key, the first mail server 103 is verified against a public key associated to the first mail server 103. In one example, the second mail server is arranged to provide the public key for the first mail server 103 from the key server 109 available over the Internet. In another example, public keys have been exchanged between the mail servers 103, 107 of the associated first and second networks 101, 106. If the identity of the mail server from which the received e-mail originates is verified, the second mail server 106 is arranged to forward the e-mail to the recipient in the manner described below.

If the received and verified e-mail does not comprise a pointer, the receiving mail server 107 is arranged to forward the e-mail directly to the recipient in a step 432.

If, on the other hand, the received, and verified e-mail comprises a pointer, and if the contents at which the pointer points is an e-mail, the following steps are performed by the second network 106. The second mail server 107 is arranged to modify the pointer in a step 424 so that it still points to the recipient user but through the secure e-mail storage proxy server 108 of the recipient's network 106. The e-mail is then sent to the mail-box of the recipient user in a step 425. The e-mail is sent using the same transport as is usually used in communication between the first and second mail servers 103. In an alternative example (not illustrated), the computer of the recipient user is arranged to modify the pointer so that it points to the recipient user through the secure e-mail storage proxy server 108. In accordance therewith, the second mail server 107 does not need to modify the pointer in the step 424 before sending it to the mail-box of the recipient user in the step 425.

As the pointer (URL) provides a link to the sender's storage server 104, the recipient of the e-mail just has to click on the pointer. In response to that, communication between the recipient and the storage server 104 of the first private network 101 is started in steps 427, 428 via the storage proxy 108. Thereby, the e-mail (with or without attachment(s)), at which the pointer points, can be downloaded to the computer of the recipient (or somewhere else in the recipient's network). If the e-mail at which the pointer points is encrypted, an encryption program of the recipient is arranged to decrypt in a step 430 the downloaded e-mail with his/her own private key. Further, the encryption program of the recipient is arranged to verify the digital certificate of the sender (user's certificate) associated to the downloaded e-mail in a step 431.

If the pointer in the received e-mail is encrypted with HTTPS, a secure tunnel is opened in a step 426. The tunnel endpoints are the storage server 104 of the first network 101 and the proxy server 108 of the second network 106. The tunnel endpoints are in known manner specified in a HTTPS certificate accessible to the storage server 104 and the proxy server 108. The e-mail or attachment at which the pointer points, is then sent in a step 427 over the connection encrypted with HTTPS to the receiver's proxy server 108. The proxy server 108 is then arranged to send the received e-mail in a step 428 to the second mail server 107, which forwards the e-mail (including or not including attachment(s)) in a step 429 to the recipient. The encryption program of the recipient is arranged to decrypt the downloaded e-mail/attachment in a step 430 with his/her own private key. Further, the e-mail program of the recipient is arranged to verify the signature of the sender (a user of the first private network 106) associated to the downloaded e-mail in the step 431. In order to enable decryption and verification, the personal computer 202 of FIG. 2 comprises in one example means for decryption and verification.

The operation of the recipient's network 106 is in FIG. 4 described in relation to the herein described sender's network 101. However, the recipient's network 106 herein described can cooperate with any storage server 104 arranged to store e-mails. In one example, the stored e-mails are signed with the signature of the sender and/or encrypted. The encryption is for example performed with a public key of the receiver.

In FIG. 8, a receiving part 840 of the at least the first second mail server 107 comprises a verification unit 841 arranged to perform the step 423 of verifying the sender as described in relation to FIG. 4. The receiving part 842 comprises also a pointer amendment unit 842 arranged to perform the step 424 of modifying the pointer in FIG. 4 before transmittal of the e-mail to the recipient. The units of the receiving part 840 are to be seen as logical units which are implemented in software and/or hardware.

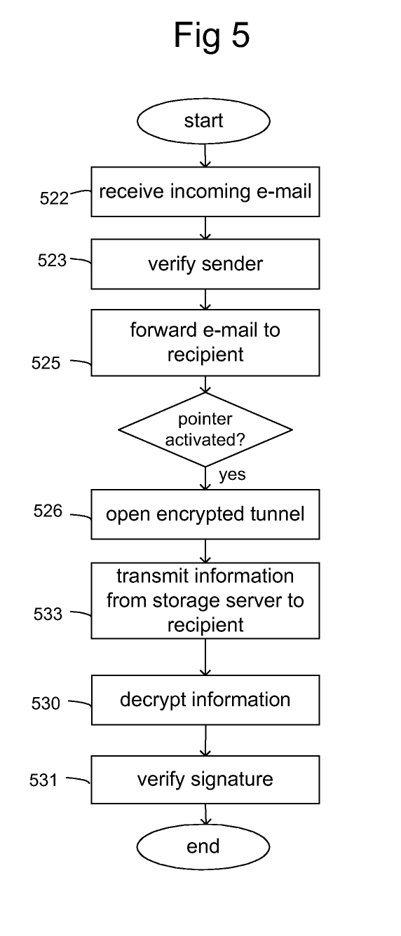

FIG. 5 describes an example, wherein the storage server 104 is arranged to store attachments on the storage server 104. The receiving mail server 107 is arranged to forward the e-mail in a step 525 directly to the recipient irrespectively whether the received (step 522) and verified (step 523) e-mail comprises a pointer or not. As the pointer (URL) provides a link to the sender's storage server 104, the recipient of the e-mail just has to click on the pointer. In response to that, communication between the recipient and the storage server 104 of the first private network 101 is started. Thereby, the attachment at which the pointer points, can be downloaded to the computer of the recipient (or somewhere else in the recipient's network) in a step 533. If the pointer uses HTTPS, the downloading is performed in the encrypted tunnel provided by HTTPS in a step 526. If the attachment itself is encrypted, an encryption program of the recipient is arranged to decrypt the downloaded attachment with his/her own private key in step 530. Further, the encryption program of the recipient is in the illustrated example arranged to verify (step 531) the digital signature of the sender (user's certificate) associated to the downloaded attachment.

In the description above, encryptions are performed using any encryption method based on the use of a public and private key (PKI). However, also other encryption methods can be used, for example those relying on storage of keys by a trusted part.

1. A mail server for a network comprising:
a sender part to
receive outgoing e-mails from users of the network,
send the received e-mails to their recipients,
copy at least some of the contents in the received e-mail to a storage, and
provide an amended e-mail based on the received e-mail, said amended e-mail comprising at least one pointer substituting the contents copied to the storage, said pointer pointing at said contents in said storage.

2. The mail server according to claim 1, wherein the pointer is a web server address.

3. The mail server according to claim 2, wherein communication with said web server address is encrypted with hypertext transfer protocol secure (HTTPS).

4. The mail server according claim 1, wherein the sender part signs the amended e-mail.

5. The mail server according to claim 4, wherein the sender part signs the amended e-mail with a key associated with the mail server.

6. The mail server according to claim 1, wherein the contents copied to the storage comprises one or a plurality of attachments.

7. The mail server according to claim 1, wherein the sender part copies the received outgoing e-mail at least some of the contents of the received outgoing e-mail to the storage.

8. The mail server according to claim 1, wherein the mail server verifies the identity of the sending user based on a signature associated to the received e-mail.

9. The mail server according to claim 1, wherein the mail server encrypts the copied contents to the storage.

10. The mail server according to claim 9, wherein the mail server encrypts the copied contents with a key associated to the recipient.

11. The mail server according to claim 1, further comprising:
a receiver part to receive incoming e-mails and to forward the incoming e-mails to their recipients present in the network served by the mail server.

12. The mail server according to claim 11, wherein the receiving part amends the pointer in the received e-mail so as to point at the destination of the pointer via a proxy server associated with the mail server.

13. The mail server according to claim 11, wherein the receiving part verifies the mail server from which an incoming e-mail originates and to, if the originating server is verified, amend the pointer in the received e-mail so as to point at the destination of the pointer via a proxy server associated with the mail server.

14. A network comprising:
a plurality of clients;
a storage; and
a mail server, coupled to the plurality of clients and the storage, and wherein the mail server comprises
a sender part to
receive outgoing e-mails from the clients and to send the received e-mails to their recipients,
copy at least some of the contents in the received e-mail to said storage, and
provide an amended e-mail based on the received e-mail, said amended e-mail comprising at least one pointer substituting the contents copied to the storage, said pointer pointing at said contents in said storage.

15. A network comprising:
a plurality of clients; and
a mail server, coupled to the plurality of clients, wherein the mail server comprises
a receiving part to
receive incoming e-mails, and
send the received e-mails to their recipients within the network,
a proxy server to amend a pointer in the received e-mail so that the pointer points at the destination of the pointer via the proxy server.

16. The network according to claim 15, wherein the pointer is encrypted with HTTPS and in that the proxy server is a channel endpoint for HTTPS.

17. The network according to claim 15, wherein the mail server verifies a mail server from which the received e-mail originates based on a signature included in the received e-mail.

18. A method for sending e-mails from users of a network to their recipients, comprising
copying at least some of the contents in the e-mail to a storage; and
providing an amended e-mail comprising at least one pointer substituting the contents copied to the storage, said pointer pointing at said contents in said storage.

19. The method according to claim 18, further comprising:
providing the pointer in the form of a web server address; and
communicating with said web server address based on HTTPS.

20. The method according to claim 18, further comprising:
signing the amended e-mail.

21. The method according to according to claim 20, wherein the amended e-mail is signed with a key associated to the mail server.

22. The method according to claim 18, wherein one or a plurality of attachments of the e-mail is copied to the storage.

23. The method according claim 18, wherein the e-mail with at least some of its contents is copied to the storage.

24. The method according to claim 18, further comprising:
verifying the identity of the sending user based on a signature associated to the received e-mail.

25. The method according to claim 18, wherein the copied contents are encrypted to the storage.

26. The method according to claim 25, wherein the copied contents are encrypted with a key associated to the recipient.

27.-28. (canceled)
